(19) United States
(12) Patent Application Publication
(10) Pub. No.: US 2026/0129296 A1
(43) Pub. Date: May 7, 2026

(54) ELECTRONIC DEVICE AND IMAGE STABILIZATION METHOD THEREOF

(71) Applicant: ASUSTeK COMPUTER INC., Taipei City (TW)

(72) Inventors: Jo-Fan Wu, Taipei City (TW); Wen-Ling Lin, Taipei City (TW)

(73) Assignee: ASUSTeK COMPUTER INC., Taipei City (TW)

(21) Appl. No.: 19/299,373

(22) Filed: Aug. 14, 2025

(30) Foreign Application Priority Data
Nov. 6, 2024 (TW) 113142467

(51) Int. Cl. H04N 23/68

(52) U.S. Cl. CPC H04N 23/683; H04N 23/6812; H04N 23/687

(57) ABSTRACT

An electronic device and an image stabilization method thereof are provided. The method is adapted to the electronic device including an image capture module, and the image capture module includes an optical image stabilization system. The method includes the following steps. Motion information of the electronic device is detected. When the image capture module generates multiple consecutive images based on multiple frame periods, a non-exposure period of a first frame period among the frame periods of the image capture module is determined. During the non-exposure period of the first frame period, the optical image stabilization system is disabled from performing an optical image stabilization compensation operation based on the motion information.

### CROSS-REFERENCE TO RELATED APPLICATION

This application claims the priority benefit of Taiwan application serial no. 113142467, filed on November 6, 2024. The entirety of the above-mentioned patent application is hereby incorporated by reference herein and made a part of this specification.

### BACKGROUND

### Technical Field

The disclosure relates to an electronic device and an image stabilization method thereof.

### Related Art

With the advancement of technology, electronic devices with imaging capabilities have become ubiquitous in modern life. To address the issue of capturing blurry images caused by vibrations during photography, the Optical Image Stabilization (OIS) function, also known as the anti-shake or anti-vibration function, includes been developed to enhance image quality.

In general, the hardware components of the OIS function can compensate for the vibrations of the imaging device to achieve image stabilization. It should be noted that the compensation angle of the OIS function is limited by the hardware and cannot provide unlimited compensation. To prevent issues such as the lens colliding with the module’s frame, the firmware design of OIS driver chips typically includes a compensation suppression mechanism to avoid collisions between the optical mechanism and the hardware boundary during intense shaking. In other words, as the lens approaches the hardware boundary, the amount of compensation is correspondingly suppressed. Consequently, when electronic devices capture consecutive images, the OIS function continues to compensate during the non-exposure periods of the image sensor. This makes it more likely for insufficient compensation to occur due to the compensation suppression mechanism.

### SUMMARY

In some embodiments, an image stabilization method is provided, which is adapted to an electronic device including an image capture module. The image capture module includes an optical image stabilization system, and the image stabilization method includes the following steps. Motion information of the electronic device is detected. When the image capture module generates a plurality of consecutive images based on a plurality of frame periods, a non-exposure time period of a first frame period among the frame periods of the image capture module is determined. During the non-exposure time period of the first frame period, the optical image stabilization system is disabled from performing the optical image stabilization compensation operation according to the motion information.

In some embodiments, an electronic device is provided, which includes an image capture module and a processor. The image capture module includes an optical image stabilization system. The processor is coupled to the image capture module and configured to perform the following operations. Motion information of the electronic device is detected. When the image capture module generates a plurality of consecutive images based on a plurality of frame periods, a non-exposure time period of a first frame period among the frame periods of the image capture module is determined. During the non-exposure time period of the first frame period, the optical image stabilization system is disabled from performing the optical image stabilization compensation operation according to the motion information.

Based on the above, in the embodiments of the disclosure, when the image capture module captures multiple consecutive images, the optical image stabilization system may be controlled to temporarily suspend the optical image stabilization compensation operation during the non-exposure time period of the image sensor. As a result, since the lens of the optical image stabilization system can temporarily pause movement during non-exposure periods, the compensation amount of the optical image stabilization system during the actual exposure period is less likely to be suppressed. This significantly enhances the compensation efficiency of the optical image stabilization system.

### BRIEF DESCRIPTION OF THE DRAWINGS

FIG. 1 is a schematic diagram illustrating an electronic device according to an exemplary embodiment.

FIG. 2 is a schematic diagram illustrating an optical image stabilization system according to an exemplary embodiment.

FIG. 3 is a flowchart illustrating an image stabilization method according to an exemplary embodiment.

FIG. 4A and FIG. 4B are schematic diagrams illustrating the disabling of optical image stabilization operations during the non-exposure time period according to an exemplary embodiment.

FIG. 5 is a flowchart illustrating the disabling of optical image stabilization operations according to an exemplary embodiment.

FIG. 6 is a schematic diagram illustrating the disabling of optical image stabilization operations during the non-exposure time periods of consecutive images according to an exemplary embodiment.

### DESCRIPTION OF THE EMBODIMENTS

Reference will now be made in detail to exemplary embodiments of this case, examples of which are illustrated in the accompanying drawings. Wherever possible, the same reference numbers are used in the drawings and the description to refer to the same or similar parts. These embodiments are only a part of this case and do not disclose all possible implementations of this case. More precisely, these embodiments are merely examples of the devices and methods within the scope of the patent claims of this case.

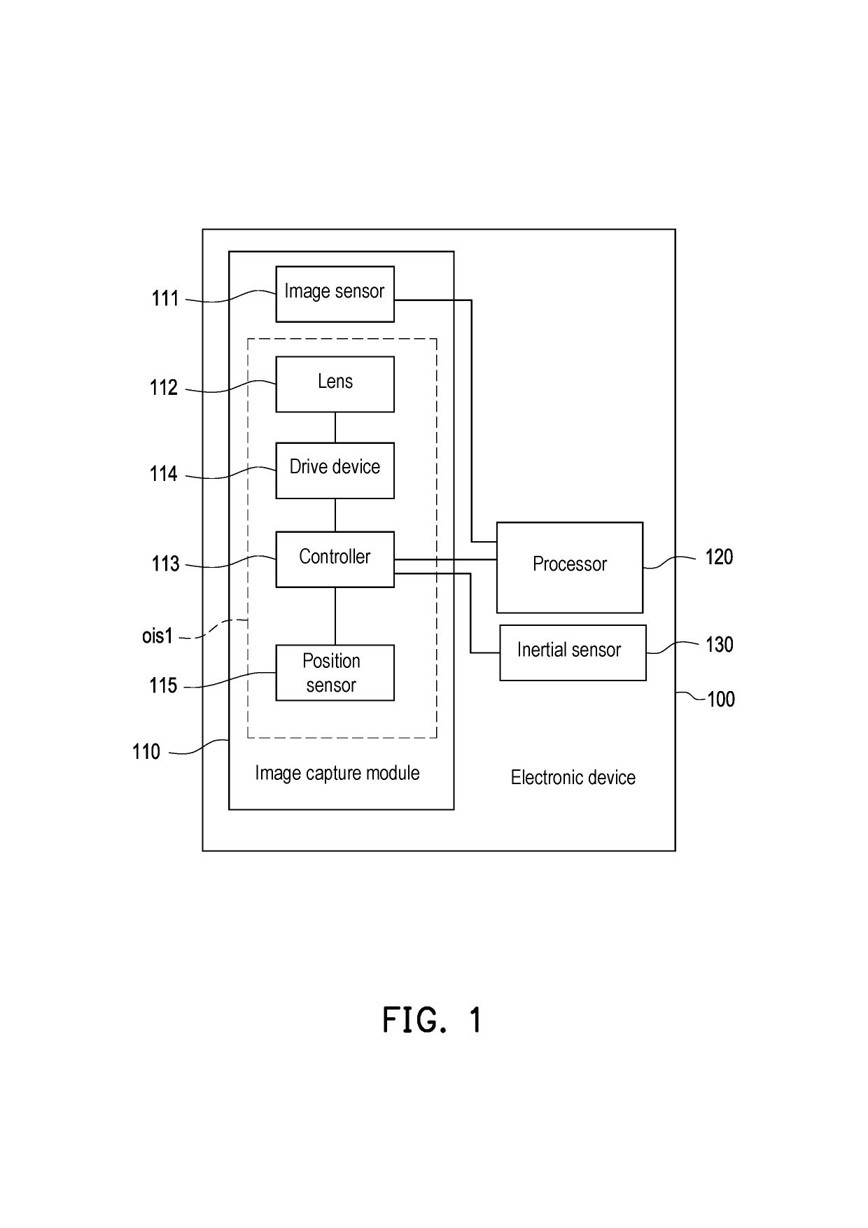

Referring to FIG. 1, the electronic device 100 may be, for example, various electronic devices with image capture function such as a smartphone, digital camera, tablet computer, game console, electronic wearable device or photographic device, but the type of electronic device 100 is not limited thereto. The electronic device 100 may include an image capture module 110, a processor 120, and an inertial sensor 130. The image capture module 110 includes an Optical Image Stabilization (OIS) system ois1. In other words, the image capture module 110 includes components related to OIS function.

The inertial sensor 130 is configured to sense motion information of the electronic device 100. The inertial sensor 130 may include an accelerometer, gyroscope, or angle sensor, etc.

The image capture module 110 is configured to capture images or videos, and include an image sensor 111 and an optical image stabilization system ois1. The optical image stabilization system ois1 may include a lens 112, a controller 113, a drive device 114, and a position sensor 115.

The image sensor 111 is configured to provide image sensing functionality. The image sensor 111 may include photosensitive components, for example, Charge Coupled Device (CCD), Complementary Metal-Oxide Semiconductor (CMOS) components or other components, which are not limited in the disclosure.

The lens 112 can gather imaging light onto the image sensor 111 to achieve the purpose of capturing images. The lens 112 is movable. In some embodiments, the lens 112 may be mounted on a micro-gimbal structure. In some embodiments, the lens 112 may move along two-dimensional axes or three-dimensional axes. In other embodiments, the optical axis direction of the lens 112 can be adjusted, meaning that the tilt angle of the lens 112 is changeable.

The drive device 114 is configured to move the lens 112 according to the control signal from the controller 113. The drive device 114 may be, for example, a Voice Coil Motor (VCM), Micro Electro-Mechanical Systems (MEMS), Shape Memory Alloys (SMA), etc.

The position sensor 115 is configured to sense the lens position of the lens 112 in real-time, and may include one or more Hall elements. For example, the position sensor 115 may be used to sense the position of the lens 112 in different axes or the tilt angle of the lens 112 in real-time.

The controller 113 is coupled to the inertial sensor 130, the position sensor 115, the drive device 114, and the processor 120. The controller 113 may be, for example, a programmable general-purpose or special-purpose microprocessor, Digital Signal Processor (DSP), programmable controller, Application Specific Integrated Circuits (ASIC), Programmable Logic Device (PLD), or other similar devices or a combination of these devices, which can load and execute software/firmware code.

The processor 120 is coupled to the image capture module 110, and the processor 120 may be, for example, an application processor (AP), or other programmable general-purpose or special-purpose microprocessor, digital signal processor (DSP), image signal processor (ISP), or other similar devices, integrated circuits or combinations thereof. The processor 120 may analyze the image data captured by the image sensor 111 to determine camera parameters (such as exposure parameters or lens focal length, etc.). For example, the processor 120 may execute an automatic exposure (AE) algorithm to determine exposure parameters, and the aforementioned exposure parameters include exposure duration (i.e., shutter speed) and exposure gain, etc.

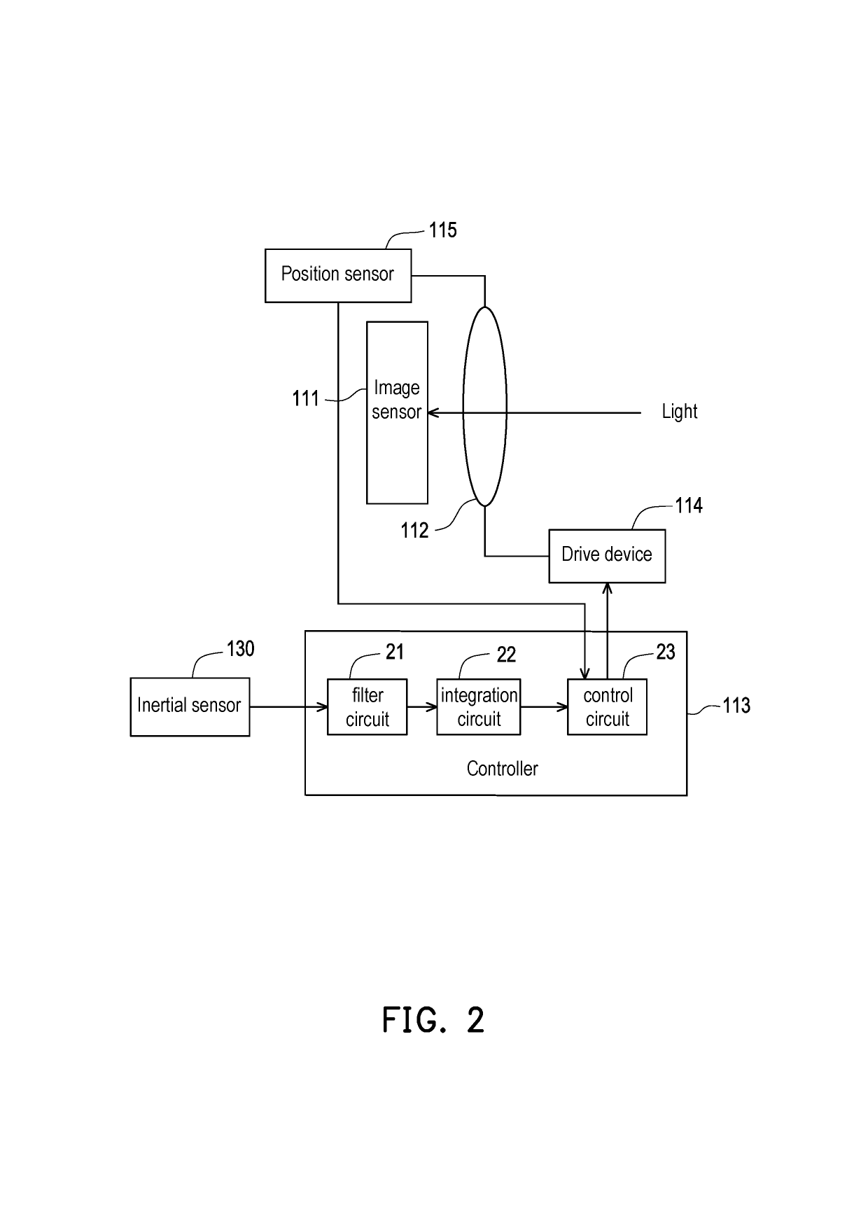

Referring to FIG. 2, in some embodiment of the invention, the drive device 114 is connected to the lens 112. The controller 113 can control the driving device 114 to adjust the position of the lens 112 along different axes (e.g., the illustrated X-axis, Y-axis, or Z-axis) or the tilt angle of the lens 112, so that the image sensed by the image sensor 111 can remain stable in various motion states such as hand tremors, head movements, or vibrations from vehicles, etc.

More specifically, when the OIS function is enabled, and the electronic device 100 experiences shaking, the controller 113 can receive motion information from the inertial sensor 130. Subsequently, the controller 113 determines the movement of the lens 112 based on the motion information. The controller 113 then controls the drive device 114 to adjust the position or tilt angle of the lens 112 along different axes to achieve vibration compensation, thereby reducing image blurring caused by the vibrations.

As shown in FIG. 2, in some embodiments, the controller 113 may include a filter circuit 21, an integration circuit 22, and a control circuit 23. The filter circuit 21 is coupled to the inertial sensor 130, and the filter circuit 21 may perform noise filtering processing on the motion information provided by the inertial sensor 130. In this embodiment, the integration circuit 22 is coupled between the filter circuit 21 and the control circuit 23, and the motion information provided by the inertial sensor 130 may be angular velocity sensing data or linear acceleration sensing data. The integration circuit 22 may be used to perform integration processing and necessary calculations on the motion information provided by the inertial sensor 130 to generate the offset (e.g., angular offset or distance offset) of the electronic device 100. The control circuit 23 obtains the offset amount of the electronic device 100 from the integration circuit 22 and determines the compensation amount according to the offset amount of the electronic device 100. Thus, the control circuit 23 may control the drive device 114 to drive the lens 112 to translate or tilt according to the aforementioned compensation amount.

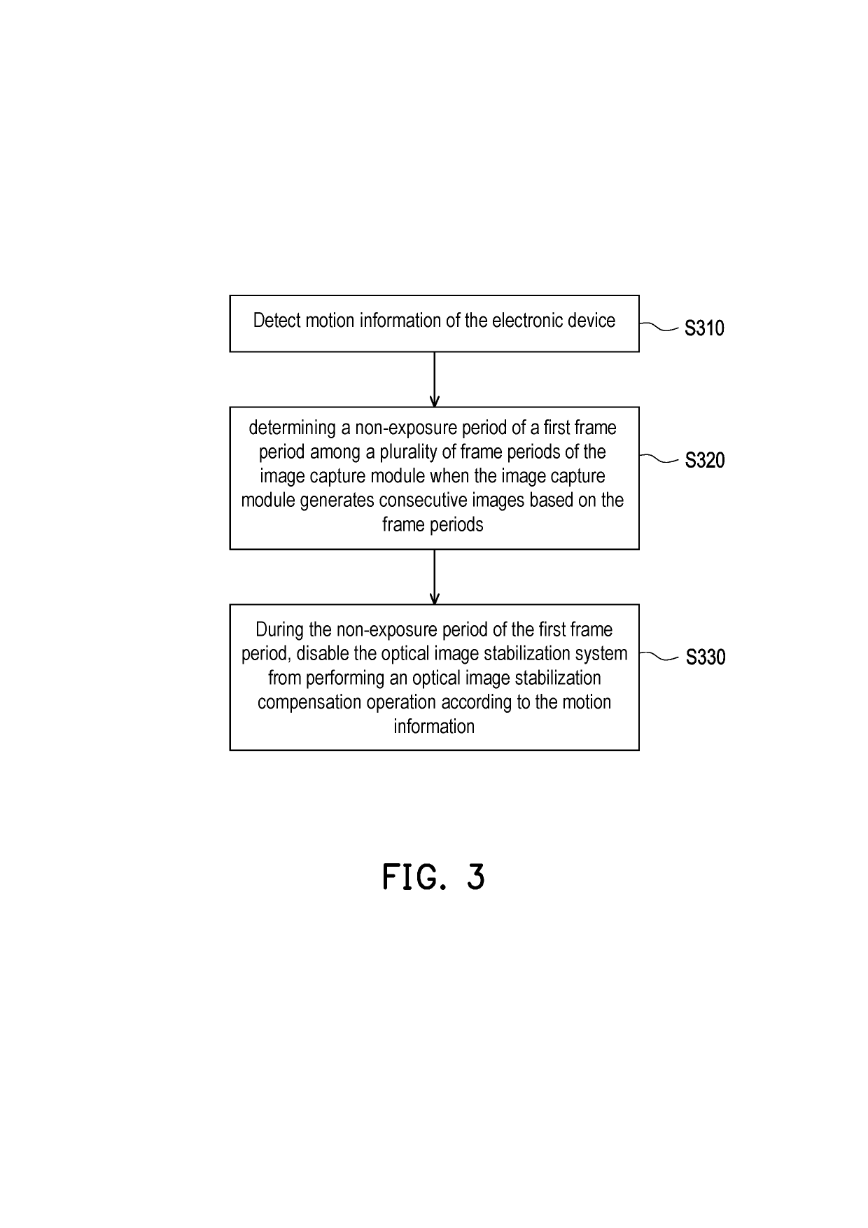

FIG. 3 is a flowchart of an image stabilization method according to an embodiment of this invention. Referring to FIG. 3, the method of the embodiment may be executed by the electronic device 100 shown in FIG. 1. The detail of each step in FIG. 3 is explained below in conjunction with the components shown in FIG. 1 and FIG. 2.

In step S310, the inertial sensor 130 may detect motion information of the electronic device 100. The motion information generated by the inertial sensor 130 may include angle sensing data, angular velocity sensing data, or linear acceleration sensing data. For example, a gyroscope may be used to sense the angular velocity generated by the shaking of the electronic device 100; an accelerometer may be used to sense the linear acceleration generated by the shaking of the electronic device 100.

In step S320, when the image capture module 110 may generate a plurality of consecutive images based on multiple frame periods, the processor 120 may determine a non-exposure period of a first frame period among the frame periods of the image capture module 110. Furthermore, when the image capture module 110 captures the consecutive images, the image capture module 110 may continuously capture multiple consecutive images at a capture frame rate (unit: fps).

Here, the frame period refers to the time interval from the start of sensing one frame of an image by the image sensor 111 to the start of sensing the next frame. The operations performed during the frame period may include image sensing, data reading, image processing, and other related processes. For example, assuming a capture frame rate of 30 fps, the image capture module 110 outputs 30 consecutive images per second, and the length of each frame period for these consecutive images would be 1/30 seconds.

In some embodiments, the processor 120 may execute an Auto Exposure (AE) algorithm to determine the length of the exposure period for each consecutive image. In other words, changes in the exposure period directly reflect the response and adjustment of the AE algorithm to the current scene brightness. The type of AE algorithm is not limited, and any AE algorithm well-known to those skilled in the art may be applied for implementation. During the exposure period, the sensing components of the image sensor 111 may perform photosensitive operations. Through executing photosensitive operations, the sensing components may perform photoelectric conversion, converting light signals into electrical signals. Furthermore, after the processor 120 obtains the exposure period for each consecutive image, the processor 120 may determine the non-exposure period for each consecutive image based on the frame period.

In some embodiments, during the exposure period of each frame period, the processor 120 may enable the optical image stabilization system ois1 to perform optical image stabilization compensation operation according to the motion information. That is, during the exposure period of each consecutive image, the optical image stabilization system ois1 performs the optical image stabilization compensation operation based on the motion information provided by the inertial sensor 130, to achieve vibration compensation and make the image clear.

It should be noted that in step S330, during the non-exposure period of the first frame period, the processor 120 may disable the optical image stabilization system ois1 from performing the optical image stabilization compensation operation according to the motion information. In other words, during the period when the image capture module 110 is recording a video or performing a burst shooting function to capture multiple consecutive images, the optical image stabilization system ois1 may temporarily suspend the optical image stabilization compensation operation in one or more non-exposure periods.

In some embodiments, during the non-exposure period of the first frame period, the controller 113 of the optical image stabilization system ois1 suspends moving the lens 112 of the image capture module 110 according to the motion information. That is, the controller 113 may control the lens 112 to temporarily suspend movement in response to the motion information during the non-exposure period. Therefore, the lens 112 may remain in a fixed position during at least one non-exposure period. As a result, compared to continuously performing optical image stabilization compensation throughout the entire frame cycle, the disclosed embodiment can significantly reduce the likelihood of the lens 112 reaching the hardware boundary during the process of capturing consecutive images. It also mitigates the adverse impact on the compensation performance of consecutive frames caused by boundary compensation suppression.

Subsequently, when the image capture module 110 generates multiple consecutive images based on multiple frame periods, the processor 120 may determine the non-exposure period of a second frame period among the multiple frame periods of the image capture module 110. The second frame period may be the next frame period after the first frame period. During the non-exposure period of the second frame period, the processor 120 may disable the optical image stabilization system ois1 from performing the optical image stabilization compensation operation according to the motion information.

In some embodiments, when capturing multiple consecutive images, the controller 113 of the optical image stabilization system ois1 may suspend the optical image stabilization compensation operation during the non-exposure period of each consecutive image. In some embodiments, when capturing multiple consecutive images, the controller 113 of the optical image stabilization system ois1 may suspend the optical image stabilization compensation operation during the non-exposure periods of some of the consecutive images.

In some embodiments, the controller 113 of the optical image stabilization system ois1 may suspend the optical image stabilization compensation operation during a target disable period within the non-exposure period. In different embodiments, the time length of the target disable period may be equal to the time length of the non-exposure period, or the time length of the target disable period may be shorter than the time length of the non-exposure period.

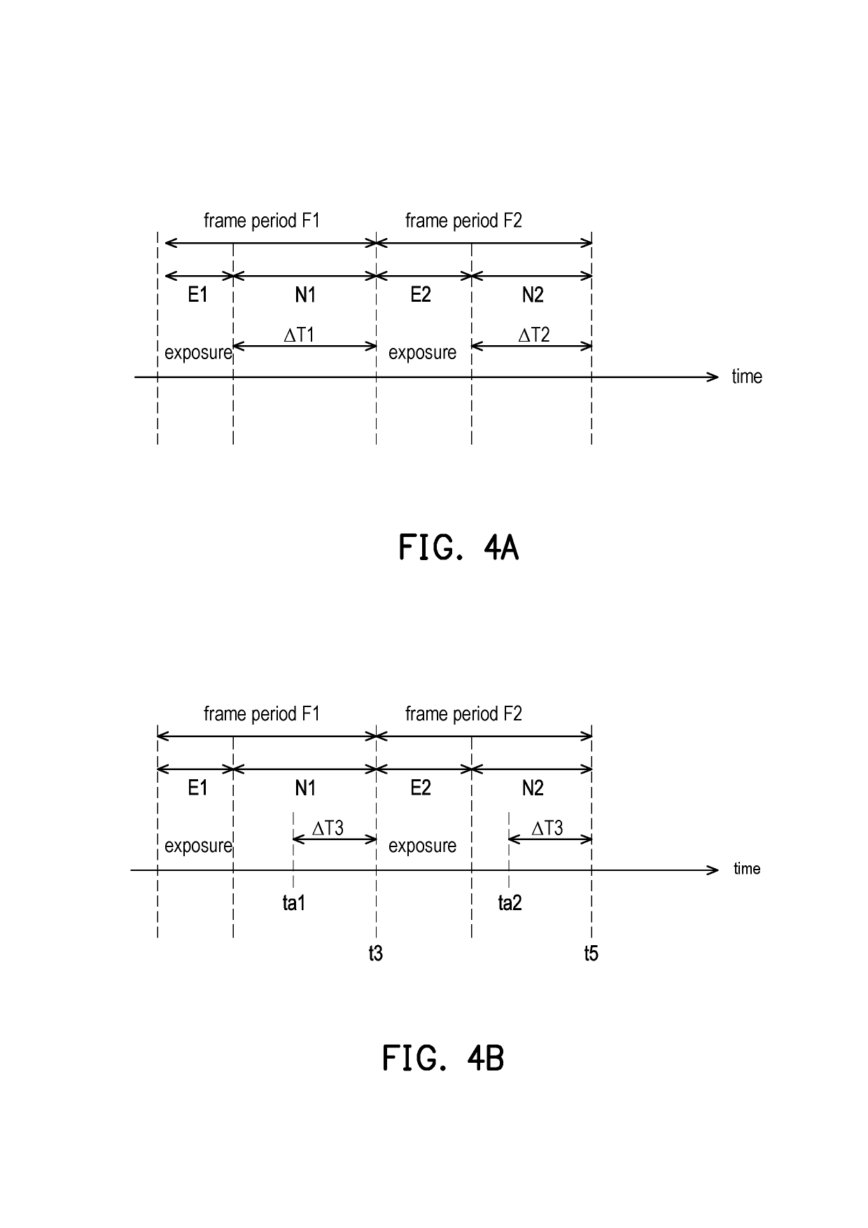

For example, referring to FIG. 4A, which is a schematic diagram illustrating the disabling of optical image stabilization operations during non-exposure periods according to embodiments of the present invention. The image sensor 111 performs the photosensitive operation during the exposure period E1 of the frame period F1, and the controller 113 of the optical image stabilization system ois1 may suspend the optical image stabilization compensation operation during a target disable period ∆T1 within the non-exposure period N1. The lens 112 may maintain a fixed position during the target disable period ∆T1. Similarly, the image sensor 111 performs photosensitive operations during the exposure period E2 of the frame period F2, and the controller 113 of the optical image stabilization system ois1 may suspend the optical image stabilization compensation operation during a target disable period ∆T2 within the non-exposure period N2. The lens 112 may maintain a fixed position during the target disable period ∆T2.

It should be noted that in the example of FIG. 4A, the length of the non-exposure period N1 is equal to the length of the target disable period ∆T1, and the length of the non-exposure period N2 is equal to the length of the target disable period ∆T2. Since the time length of the exposure period E1 in frame period F1 may be different from the time length of the exposure period E2 in frame period F2, the time length of the non-exposure period N1 is different from the time length of the non-exposure period N2. Correspondingly, the target disable period ∆T1 in frame period F1 is different from the target disable period ∆T2 in frame period F2. In other words, in some embodiments, the target disable periods for disabling the optical image stabilization compensation operation within different non-exposure periods may be different from each other.

In contrast, in some other embodiments, the time length of the target disable periods in each frame period may be the same preset value. In other words, in some embodiments, the target disable periods for disabling the optical image stabilization compensation operation within different non-exposure periods may be the same. Referring to FIG. 4B, the controller 113 of the optical image stabilization system ois1 may suspend the optical image stabilization compensation operation during the target disable periods ∆T3 within the non-exposure periods N1 and N2 respectively. In this example, the controller 113 may determine the time points ta1 and ta2 to suspend the optical image stabilization compensation operation according to the time length of the target disable period ∆T3 (which is a fixed preset value) and the exposure start time points t3 and t5.

In other words, in some embodiments, to ensure that the optical image stabilization system ois1 does not suspend the optical image stabilization compensation operation during the exposure period, the target disable period for suspending the optical image stabilization compensation operation is decided according to the exposure start time point and exposure end time point of each frame period.

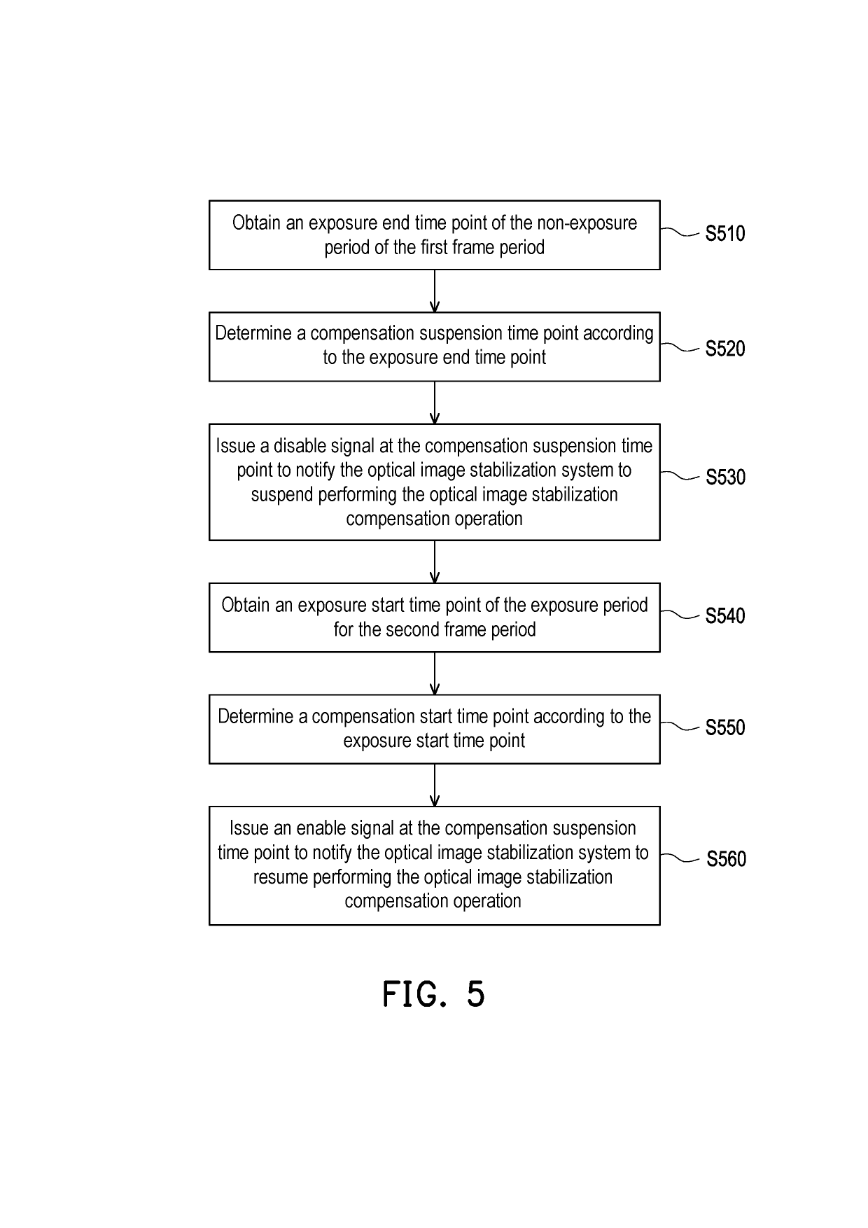

Referring to FIG. 5, which is a flowchart illustrating the process of disabling optical image stabilization operations according to an embodiment of the present invention. In step

S510, the processor 120 may obtain a exposure end time point of the non-exposure period of the first frame period. As mentioned earlier, the processor 120 may obtain the exposure period for each frame period after performing the automatic exposure operation, and obtain the exposure end time point of the exposure period for each frame period.

In step S520, the processor 120 may determine a compensation suspension time point according to the exposure end time point. In step S530, the processor 120 may issue a disable signal at the compensation suspension time point to notify the optical image stabilization system ois1 to suspend performing the optical image stabilization compensation operation.

In some embodiments, the processor 120 may determine a compensation suspension time point according to the exposure end time point through a preset function. In some embodiments, the processor 120 may obtain a compensation suspension time point by adjusting the exposure end time point according to a time difference. This compensation suspension time point equals the exposure end time point minus the time difference.

For example, assuming the exposure end time point is TP1 and the time difference is Δtt1, then the compensation suspension time point equals TP1-Δtt1. The processor 120 may issue a disable signal at the compensation suspension time point TP1-Δtt1 to notify the optical image stabilization system ois1 to suspend performing the optical image stabilization compensation operation. The aforementioned time difference Δtt1 may be a preset value. In some embodiments, the aforementioned time difference Δtt1 may be decided according to the transmission delay between the optical image stabilization system ois1 and the processor 120. In some embodiments, the aforementioned time difference Δtt1 may be decided according to the transmission delay between the controller 113 and the drive device 114 of the optical image stabilization system ois1.

In other words, due to the transmission delay existing between the optical image stabilization system ois1 and the processor 120, as well as between the controller 113 and the drive device 114, the processor 120 may need to notify the optical image stabilization system ois1 to

suspend performing the optical image stabilization compensation operation earlier than the exposure end time point. This is to ensure that the lens 112 in the optical image stabilization system ois1 may suspend movement at the exposure end time point, thereby reducing the amount of movement of the lens 112 during the non-exposure period. Based on this, if the lens 112 can be controlled to suspend movement at the exposure end time point, it may reduce the probability of the compensation amount being suppressed due to the lens closing to the frame boundary during the exposure period.

In step S540, the processor 120 may obtain an exposure start time point of the exposure period for the second frame period. The second frame period is the next frame period after the first frame period. It is known that, in some embodiments, the exposure start time point of the exposure period for the second frame period equals the frame start time point of the second frame period. In other embodiments, the exposure start time point of the exposure period for the second frame period may be another time point within the second frame period. In other words, the exposure period can be positioned in either the early part or the latter part of the frame period, which is not limited.

In step S550, the processor 120 may determine a compensation start time point according to the exposure start time point. In step S560, the processor 120 may issue an enable signal at the compensation suspension time point to notify the optical image stabilization system ois1 to resume performing optical image stabilization compensation operation.

In some embodiments, the processor 120 may determine a compensation start time point according to the exposure start time point through a preset function. In some embodiments, the processor 120 may obtain a compensation start time point by adjusting the exposure start time point according to a time difference. This compensation start time point equals the exposure start time point minus the time difference.

For example, assuming the exposure start time point is TP2 and the time difference is Δtt2, then the compensation start time point equals TP2-Δtt2. The processor 120 may issue an

enable signal at the compensation start time point TP2-Δtt2 to notify the optical image stabilization system ois1 to resume performing optical image stabilization compensation operation. The aforementioned time difference Δtt2 may be a preset value. In some embodiments, the aforementioned time difference Δtt2 may be decided according to the signal transmission delay between the optical image stabilization system ois1 and the processor 120 and/or the signal transmission delay between the controller 113 and the drive device 114.

In other words, due to the signal transmission delay existing between the optical image stabilization system ois1 and the processor 120, and the signal transmission delay existing between the controller 113 and the drive device 114, the processor 120 needs to notify the optical image stabilization system ois1 to resume performing the optical image stabilization compensation operation earlier than the exposure start time point, to ensure that the lens 112 in the optical image stabilization system ois1 may start responding to motion information and move at the exposure start time point.

Alternatively, in some other embodiments, since the time references of different systems may be inconsistent, the aforementioned time difference Δtt2 may be decided according to the differences between different time systems. For example, the time system for exposure control may be different from the time system of the optical image stabilization system ois1, but this difference is usually fixed and can be calibrated. Based on this, through timing calibration tests, the difference between the time system used by the optical image stabilization system ois1 and the time system used by the processor 120 can be determined, thereby obtaining the time difference Δtt2 to determine the timing for issuing an enable signal.

In some embodiments, when the optical image stabilization system ois1 suspends performing optical image stabilization compensation operation at the exposure end time point of the first frame period, the lens 112 of the image capture module 110 stays at a first lens position at the exposure end time point. Subsequently, when the optical image stabilization system ois1 resumes performing optical image stabilization compensation operation at the exposure start time

point of the second frame period, the lens 112 of the image capture module 110 starts moving from the first lens position. In other words, between the exposure end time point and the exposure start time point, the lens 112 may be fixed at the first lens position and does not respond to motion information by moving.

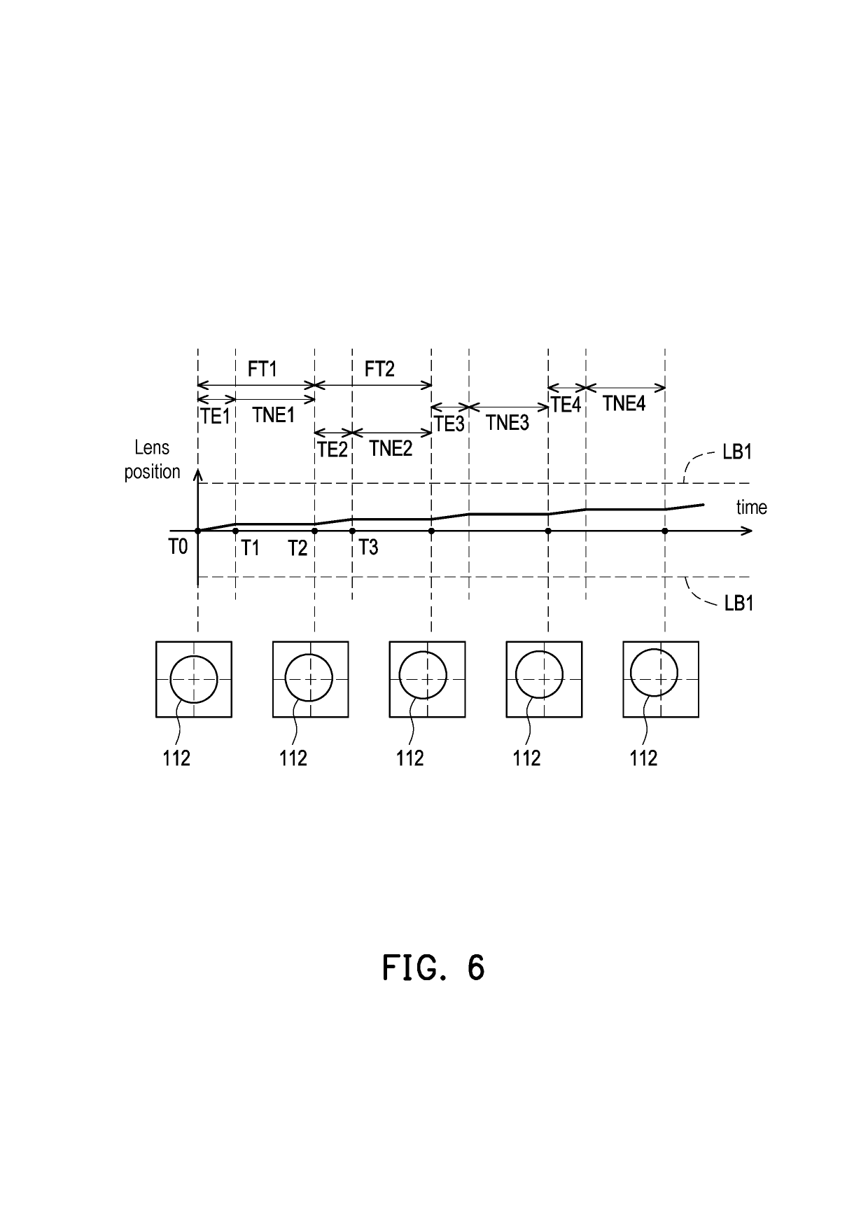

Referring to FIG. 6, which is a schematic diagram illustrating the disabling of optical image stabilization operations during non-exposure time periods of consecutive images according to embodiments of the present invention. Within the frame period FT1, the image sensor 111 starts photosensitive operations at the exposure start time point T0 of the exposure time period TE1, and completes photosensitive operations at the exposure end time point T1. The optical image stabilization system ois1 suspends executing optical image stabilization compensation operation during the non-exposure time period TNE1 of the frame period FT1. Therefore, during the exposure time period TE1, the lens 112 moves from the first lens position to the second lens position. During the non-exposure time period TNE1, the lens position of the lens 112 remains unchanged.

Subsequently, within the frame period FT2, the image sensor 111 starts photosensitive operations at the exposure start time point T2 of the exposure time period TE2, and completes photosensitive operations at the exposure end time point T3. Therefore, the optical image stabilization system ois1 resumes performing the optical image stabilization compensation operation at the exposure start time point T2 of the exposure time period TE2, until the exposure end time point T3 of the exposure time period TE2. Then, the optical image stabilization system ois1 suspends performing the optical image stabilization compensation operation during the non-exposure time period TNE2 of the frame period FT2. Consequently, during the non-exposure time period TNE2, the lens position of the lens 112 remains unchanged.

Similarly, the optical image stabilization system ois1 may execute the optical image stabilization compensation operation during the exposure time periods TE3, TE4, and suspends performing the optical image stabilization compensation operation during the non-exposure time

periods TNE3, TNE4. Since the lens 112 may stop moving during the non-exposure time periods TNE1, TNE2, TNE3, TNE4, it may reduce the extent to which the lens position of the lens 112 moves towards the hardware boundary LB1 of the maximum movable range.

In summary, in the embodiments of the disclosure, when the image capture module captures multiple consecutive images, the optical image stabilization system may be controlled to suspend the optical image stabilization compensation operation during the non-exposure time periods of the image sensor. As a result, since the lens of the optical image stabilization system can temporarily pause movement during non-exposure periods, the compensation amount of the optical image stabilization system during the actual exposure period is less likely to be suppressed, thereby significantly enhancing the compensation efficiency of the optical image stabilization system. Based on this, by pausing optical image stabilization compensation operations during non-exposure periods, unnecessary lens movement compensation can be avoided. This greatly reduces the likelihood of the lens reaching the hardware boundary during the continuous image capture process.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. An image stabilization method, adapted to an electronic device comprising an image capture module, the image capture module comprising an optical image stabilization (OIS) system, the method comprising:
detecting motion information of the electronic device;
determining a non-exposure time period of a first frame period among a plurality of frame periods of the image capture module when the image capture module generates a plurality of consecutive images based on the frame periods; and
during the non-exposure time period of the first frame period, disabling the optical image stabilization system from performing an optical image stabilization compensation operation according to the motion information.

2. The image stabilization method as claimed in claim 1, further comprising:
during an exposure time period of each of the frame periods, enabling the optical image stabilization system to perform the optical image stabilization compensation operation according to the motion information.

3. The image stabilization method as claimed in claim 2, wherein the step of during the non-exposure time period of the first frame period, disabling the optical image stabilization system from performing the optical image stabilization compensation operation according to the motion information comprises:
during the non-exposure time period of the first frame period, suspending moving lens of the image capture module according to the motion information.

4. The image stabilization method as claimed in claim 1, wherein the step of during the non-exposure time period of the first frame period, disabling the optical image stabilization system from performing the optical image stabilization compensation operation according to the motion information comprises:
obtaining an exposure end time point of the non-exposure time period of the first frame period;
determining a compensation suspension time point according to the exposure end time point; and
at the compensation suspension time point, issuing a disable signal to notify the optical image stabilization system to suspend performing the optical image stabilization compensation operation.

5. The image stabilization method as claimed in claim 4, wherein the step of determining the compensation suspension time point according to the exposure end time point comprises:
adjusting the exposure end time point according to a time difference to obtain the compensation suspension time point, wherein the compensation suspension time point equals the exposure end time point minus the time difference.

6. The image stabilization method as claimed in claim 4, wherein the step of during the non-exposure time period of the first frame period, disabling the optical image stabilization system from performing the optical image stabilization compensation operation according to the motion information comprises:
obtaining an exposure start time point of the exposure time period of a second frame period;
determining a compensation start time point according to the exposure start time point; and
at the compensation start time point, issuing an enable signal to notify the optical image stabilization system to resume performing the optical image stabilization compensation operation.

7. The image stabilization method as claimed in claim 6, wherein the step of determining the compensation start time point according to the exposure start time point comprises:
adjusting the exposure start time point according to a time difference to obtain the compensation start time point, wherein the compensation start time point equals the exposure start time point minus the time difference.

8. The image stabilization method as claimed in claim 6, wherein when the optical image stabilization system suspends performing the optical image stabilization compensation operation at the exposure end time point of the first frame period, lens of the image capture module stays at a first lens position at the exposure end time point; when the optical image stabilization system resumes performing the optical image stabilization compensation operation at the exposure start time point of the second frame period, the lens of the image capture module starts moving from the first lens position.

9. The image stabilization method as claimed in claim 1, further comprising:
determining a non-exposure time period of a second frame period among the frame periods of the image capture module when the image capture module generates the consecutive images based on the frame periods; and
during the non-exposure time period of the second frame period, disabling the optical image stabilization system from performing the optical image stabilization compensation operation according to the motion information.

10. An electronic device, comprising:
an inertial sensor, configured to detect motion information of the electronic device;
an image capture module, comprising an optical image stabilization system; and
a processor, coupled to the image capture module, and configured to:
determine a non-exposure time period of a first frame period among a plurality of frame periods of the image capture module when the image capture module generates a plurality of consecutive images based on the frame periods; and
during the non-exposure time period of the first frame period, disable the optical image stabilization system from performing an optical image stabilization compensation operation according to the motion information.
